(19) United States
(12) Patent Application Publication
(10) Pub. No.: US 2016/0078544 A1
(43) Pub. Date: Mar. 17, 2016

(54) SYSTEM FOR OPTIMIZING PREMIUM DATA

(71) Applicant: Hartford Fire Insurance Company, Hartford, CT (US)

(72) Inventor: Timothy P. Brady, Easton, CT (US)

(21) Appl. No.: 14/488,636

(22) Filed: Sep. 17, 2014

(51) Int. Cl. G06Q 40/08

(52) U.S. Cl. CPC G06Q 40/08

(57) ABSTRACT

According to some embodiments, systems, methods, apparatus, computer program code and means may facilitate calculation of an insurance premium for an insurance product. Insurance risk factor data associated with the insurance product may be received along with insurance loss experience data. A server may interact with remote potential insurance customer devices to collect potential insurance customer price responsive behavior information associated with the insurance product. A pricing platform may receive information from a first remote potential insurance customer device, associated with a first potential insurance customer, and automatically calculate an insurance premium for the insurance product based on at least the insurance risk factor data, the insurance loss experience data, and the collected potential insurance customer price responsive behavior information. An indication of the calculated insurance premium may then be transmitted to the first potential insurance customer device.

### FIELD

The present invention relates to computer systems and more particularly to computer systems that facilitate administration of insurance based premium data.

### BACKGROUND

To determine an appropriate premium for an insurance product, an underwriter (e.g., associated with an insurer) may consider risk factors and exposures, overlay this information with known loss experiences from similar products, and add an amount in view of anticipated expenses and profit. While recent advances in technology have made this process more efficient, and given underwriters access to a larger volume of information (e.g., risk factors, exposures, loss experience, expenses, and/or profit values), the advances have not fundamentally changed the process for calculating a price for an insurance product. After the sale of the insurance product, performance may be periodically measured by the insurer. For example, the components that were used to calculate the premium might be compared to overall company experiences, along with specific account exposures, and adjustments might be made to the premium. Note that premiums might be adjusted up or down depending on whether the comparisons are favorable (e.g., expenses have been lower than planned) or unfavorable (e.g., actual losses have been worse than originally contemplated). In some cases, prospective customer flow—website hits, submissions, quotes, and/or binds—may be compared against other company experiences. If an insurance product is “not successful,” that is the insurer is quoting and writing fewer policies than expected, that might be considered an indication of, for example: non-competitive pricing; coverages and terms being less favorable than marketplace alternatives; insufficient marketing; etc.

Note, however, that these approaches have several disadvantages. For example, the success with respect to any given potential customer is binary (e.g., he or she either did or did not purchase the insurance product). Moreover, there may be no sense of magnitude with respect to what it might have taken to win, or keep, the business. In addition, it may be difficult to determine lost opportunity costs and/or make adjustments that do not lag market realities.

It would therefore be desirable to provide systems and methods to promote the pricing of an insurance product in an automated, efficient, and accurate manner.

### SUMMARY

According to some embodiments, systems, methods, apparatus, computer program code and means may promote pricing of an insurance premium. In some embodiments, systems, methods, apparatus, computer program code and means may facilitate calculation of an insurance premium for an insurance product. Insurance risk factor data associated with the insurance product may be received along with insurance loss experience data. A server may interact with remote potential insurance customer devices to collect potential insurance customer price responsive behavior information associated with the insurance product. A pricing platform may receive information from a first remote potential insurance customer device, associated with a first potential insurance customer, and automatically calculate an insurance premium for the insurance product based on at least the insurance risk factor data, the insurance loss experience data, and the collected potential insurance customer price responsive behavior information. An indication of the calculated insurance premium may then be transmitted to the first potential insurance customer device.

A technical effect of some embodiments of the invention is an improved and computerized method to promote pricing of an insurance product. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 is a graph illustrating how the likelihood of interest by potential customers might change in response to different insurance premiums in accordance with some embodiment.

FIG. 4 is another graph illustrating how insurance sales might be influenced by the display of other insurance plans in accordance with some embodiment.

FIG. 5 is block diagram of an insurance pricing tool or platform according to some embodiments of the present invention.

FIG. 6A is a tabular portion of a price responsive behavior database according to some embodiments.

FIG. 6B is a tabular portion of a price responsive behavior database according to another embodiment.

FIG. 7 illustrates a follow-up process flow in accordance with some embodiments.

FIG. 8 illustrates a computer display associated with multiple insurance products in accordance with some embodiments described herein.

FIG. 9 illustrates a handheld tablet results display according to some embodiments described herein.

FIG. 10 illustrates a computer display associated with multiple insurers in accordance with some embodiments described herein.

FIG. 11 is a block diagram that illustrates aspects of a predictive model computer system provided in accordance with some embodiments of the invention.

### DETAILED DESCRIPTION

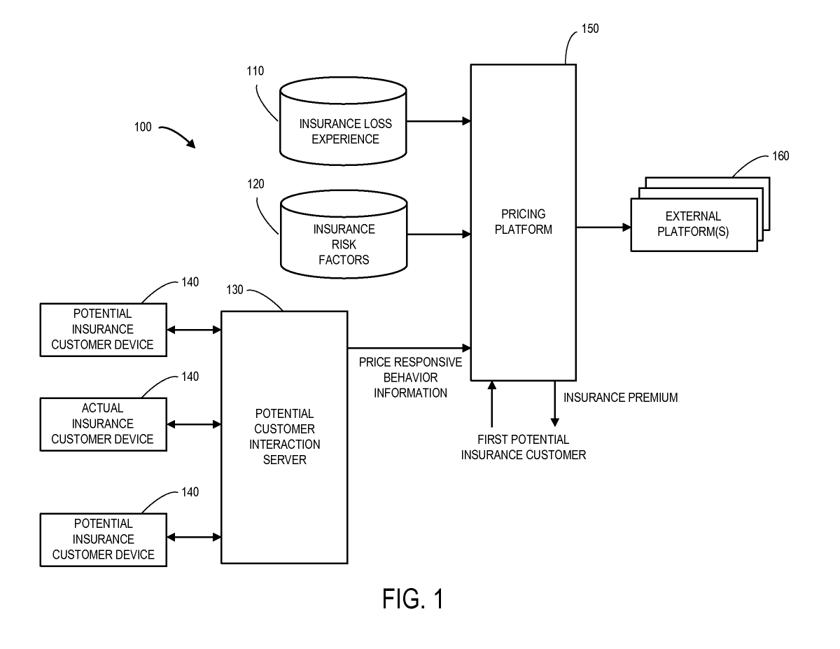

Some embodiments described herein may identify and/or quantify customer purchasing decisions and patterns and incorporate this information into an insurance pricing model before finalizing and optimizing the premium and offering an insurance product for sale. Further, some embodiments may provide a mechanism that tracks marketplace reaction to insurer pricing and product offerings to subsequently adjust pricing on a substantially “real-time” basis. FIG. 1 is block diagram of a system 100 according to some embodiments of the present invention. In particular, the system 100 includes a pricing platform 150 that receives information from an insurance loss experience database 110 (e.g., based on actual claims that were submitted for similar insurance products) and an insurance risk factor database 120 (e.g., storing risk information about customer, types of property, types of business, etc.).

The pricing platform 150 might be, for example, associated with a Personal Computers (PC), laptop computer, an enterprise server, a server farm, and/or a database or similar storage devices. A potential customer interaction server 130 may exchange information with a number of potential insurance customer devices 140 (e.g., via web interactions) and transmit price responsive behavior information to the pricing platform 150. The potential insurance customer devices 140 might be associated with, for example, customers who have actually purchased insurance products and/or parties who have requested or received information about insurance product. The potential customer interaction server 130 may, according to some embodiments, be associated with an insurance provider. In other cases, the potential customer interaction server 130 might be associated with a vendor, such as a technology company that provides pricing services for a number of different insurance providers.

According to some embodiments, an “automated” pricing platform 150 may help promote pricing of an insurance product. For example, the pricing platform 150 may automatically output an appropriate insurance premium to a potential insurance customer. As used herein, the terms “automated” and “automatically” may refer to, for example, actions that can be performed with little (or no) intervention by a human.

As used herein, devices, including those associated with the pricing platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The pricing platform 150 may store information into and/or retrieve information from the databases 110, 120. The databases 110, 120 might be associated with, for example, clients and/or insurance policies and might store data associated with past and current insurance premiums and claims. The databases 110, 120 might be locally stored or reside remote from the pricing platform 150. As will be described further below, elements of the system 100 may be used by the pricing platform 150 to generate predictive models. According to some embodiments, the pricing platform 150 communicates information about insurance premiums, such as by transmitting an electronic file to potential customers, a client device, an insurance agent or analyst platform, an email server, a workflow management system, etc.

Although a single pricing platform 150 is shown in FIG. 1, any number of such devices may be included. Moreover, various devices described herein might be combined according to embodiments of the present invention. For example, in some embodiments, the pricing platform 150 and potential customer interaction server 130 might be co-located and/or may comprise a single apparatus.

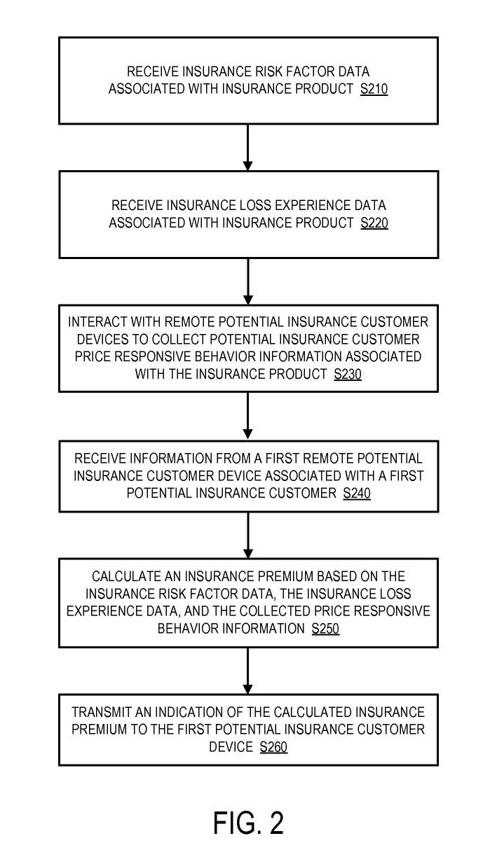

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, insurance risk factor data associated with an “insurance product” may be received. Embodiments described herein may be associated with any type of insurance product, including, for example, products for workers' compensation insurance, disability insurance (e.g., including long and short term disability insurance), property insurance, automobile insurance, life insurance, professional liability insurance, casualty insurance, workers' compensation insurance, directors and officers liability insurance, etc. Moreover, the insurance product might be associated with any of a number of different market segments, such as personal insurance, small commercial, middle market, micro-insurance products, etc. The risk factor data might represent, for example, demographic information, geographic locations, etc. At S220, insurance loss experience data associated with the insurance product may be received. The loss experience information might be associated with, for example, actual claims and amounts that were submitted in connections with existing insurance policies.

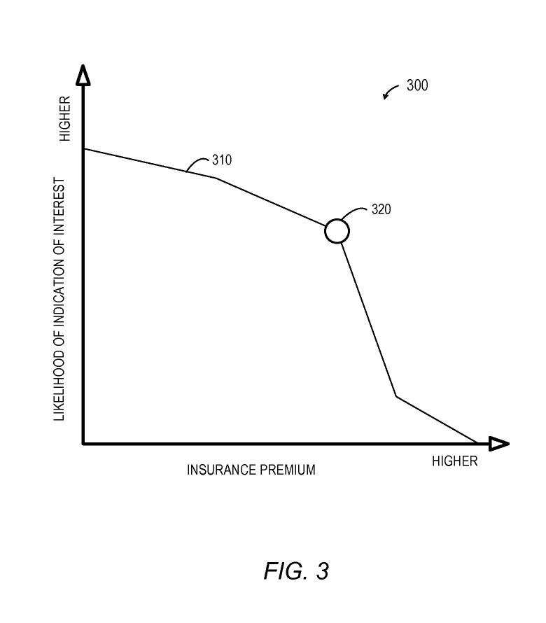

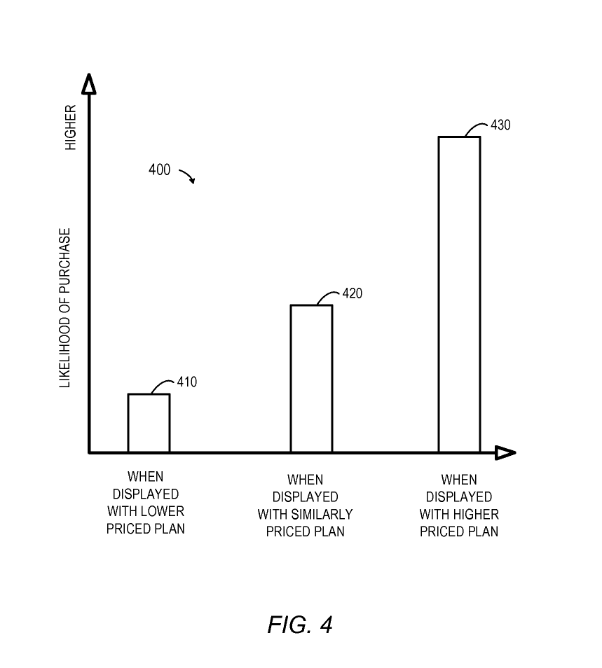

At S230, interactions may occur with remote potential insurance customer devices to collect potential insurance customer price responsive behavior information associated with the insurance product. As used herein, the phrase “potential insurance customer” might refer to both consumers who actually purchased an insurance product as well as consumers who purchased a different insurance product (or even those who purchased no insurance product at all). For example, it might be determined whether or not visitors to a web page clicked on a “more information” icon associated with various insurance products (or insurers) at various price points (indicating the visitors were—or were not—interested in the insurance product at the various price points). According to some embodiments, the price responsive behavior might comprise whether or not visitors actually purchased the insurance product. Consider, for example, FIG. 3 which is a graph 300 illustrating how the likelihood of interest 310 by potential customers might decrease as insurance premiums rise. According to some embodiments, this information may be used to select an appropriate premium 320 for a particular customer (or class of customers). For example, it might be automatically determined that a premium price can be increased (or decreased) as compared to similar products offered by other insurers to improve an overall profit goal. As another example, FIG. 4 is a graph 400 illustrating how insurance sales might be influenced by the display of other insurance plans in accordance with some embodiment. In particular, fewer sales 410 might be made when the insurance product is displayed alongside a lower priced plan as compared to the sales 420 when the insurance product is displayed alongside a similarly priced plan. Similarly, sales 430 might be even higher when the insurance product is displayed alongside a higher priced insurance plan.

Referring again to FIG. 2, at S240 information may be received from a first remote potential insurance customer device associated with a first potential insurance customer. For example, the information might be received when the first potential insurance customer visits a web page associated with the insurance product. At S250, an insurance premium for the insurance product may be automatically calculated for the first potential insurance customer based on at least the insurance risk factor data, the insurance loss experience data, and the collected potential insurance customer price responsive behavior information.

At S260, an indication of the calculated insurance premium may be automatically transmitted to the first potential insurance customer device. For example, an indication of the premium might be displayed on the web page associated with the insurance product. In other cases, an email text or advertisement message might be transmitted to potential customers who fit a pre-determined profile. As yet another example, information might be transmitted to an email server, a workflow application, a calendar application, or a social networking site (e.g., an offer might be posted to a social networking site). According to some embodiments, an indication of acceptance may be received from the first remote potential insurance customer and, responsive to the received indication, a sale of the insurance product might be automatically facilitated. Moreover, subsequent to the sale, experiences, including sales, profitability, and/or market knowledge data may be evaluated to adjust the calculated insurance premium as appropriate.

According to some embodiments, the insurance premium is dynamically calculated for potential customers utilizing a dynamic pricing model. The pricing might, for example, start at a base level that is determined with underwriting of the entire group census file. The dynamic pricing may allow for ongoing price decreases as potential customers indicate interest in the product. An online enrollment service may use a dynamic pricing algorithm that provides real-time pricing updates depending on the current level of interest and/or actual sales of the product.

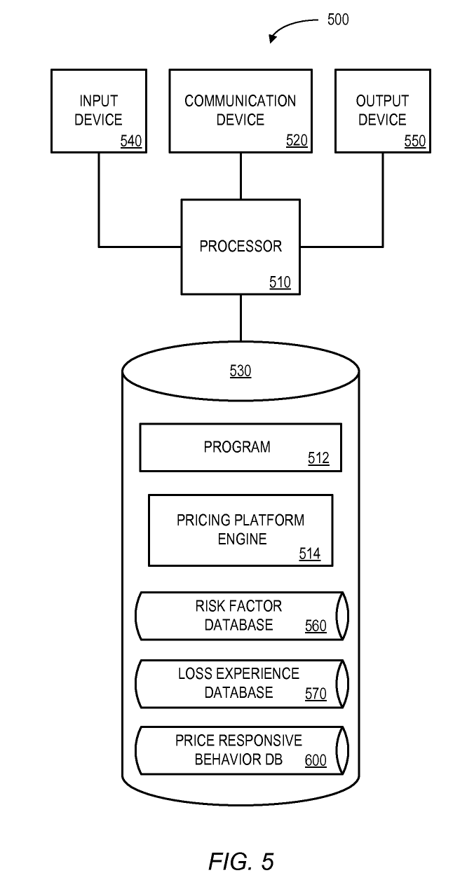

The embodiments described herein may be implemented using any number of different hardware configurations. For example, FIG. 5 illustrates an insurance pricing platform 500 that may be, for example, associated with the system 100 of FIG. 1. The insurance pricing platform 500 comprises a processor 510, such as one or more commercially available Central Processing Units (CPUs) in the form of one-chip microprocessors, coupled to a communication device 520 configured to communicate via a communication network (not shown in FIG. 5). The communication device 520 may be used to communicate, for example, with one or more potential insurance customer devices and/or interaction servers. The insurance pricing platform 500 further includes an input device 540 (e.g., a mouse and/or keyboard to enter information about an insurance premium function) and an output device 550 (e.g., to output reports and the results of pricing decisions). Note that the insurance pricing platform 500 might be associated with an insurer and/or perform processes on behalf of other, third-party insurance companies.

The processor 510 also communicates with a storage device 530. The storage device 530 may comprise any appropriate information storage device, including combinations of magnetic storage devices (e.g., a hard disk drive), optical storage devices, mobile telephones, and/or semiconductor memory devices. The storage device 530 stores a program 512 and/or a pricing platform engine 514 for controlling the processor 510. The processor 510 performs instructions of the programs 512, 514, and thereby operates in accordance with any of the embodiments described herein. For example, the processor 510 may receive insurance risk factor data and loss experience associated with an insurance product. A server may interact with remote potential insurance customer devices to collect potential insurance customer price responsive behavior information associated with the insurance product. The processor 510 may receive information from a first remote potential insurance customer device, associated with a first potential insurance customer, and automatically calculate an insurance premium for the insurance product based on at least the insurance risk factor data, the insurance loss experience data, and the collected potential insurance customer price responsive behavior information. An indication of the calculated insurance premium may then be transmitted by the processor 510 to the first potential insurance customer device.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the insurance pricing platform 500 from another device; or (ii) a software application or module within the insurance pricing platform 500 from another software application, module, or any other source.

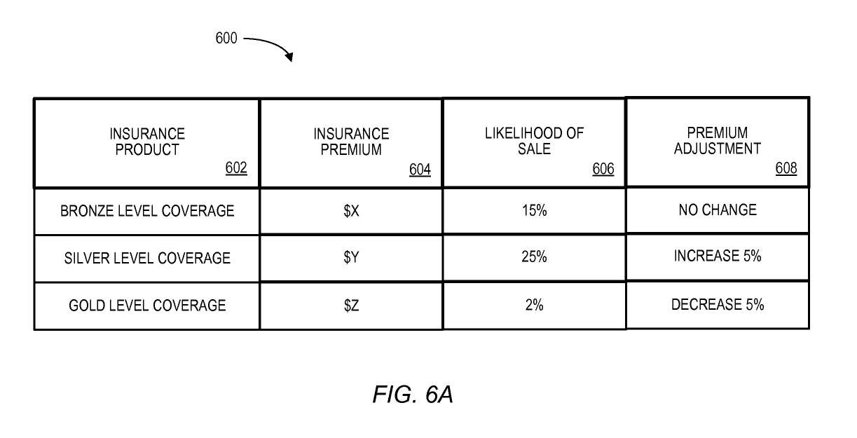

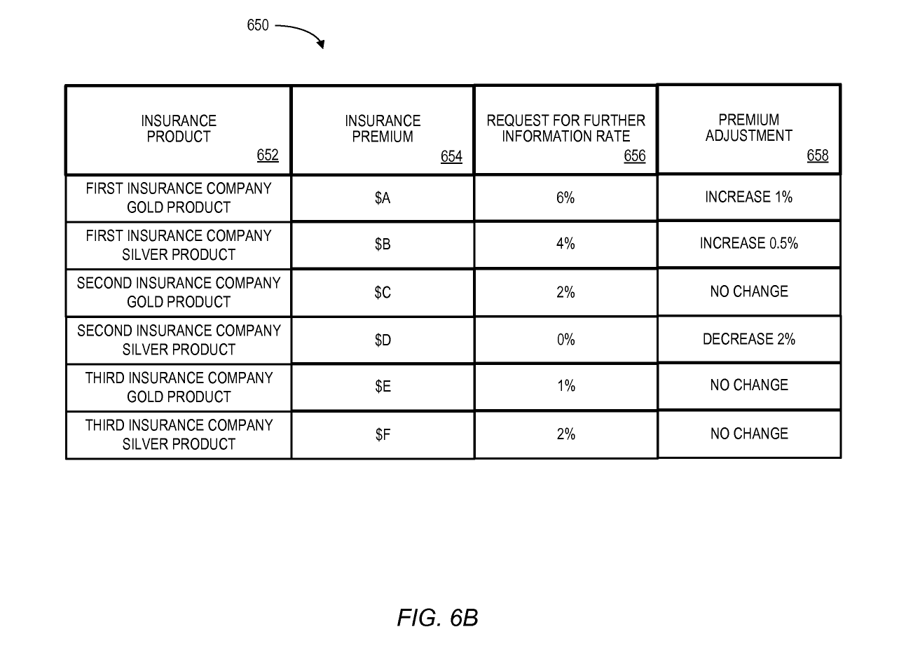

In some embodiments (such as shown in FIG. 5), the storage device 530 further stores a risk factor database 560 (e.g., indicating insured ages) loss experience database 570 (e.g., to price future insurance plans appropriately). An example of a database that may be used in connection with the insurance pricing platform 500 will now be described in detail with respect to FIG. 6A. Note that the database described herein is only one example, and additional and/or different information may be stored therein. Moreover, various databases might be split or combined in accordance with any of the embodiments described herein. For example, the risk factor database 560 and/or loss experience database 570 might be combined and/or linked to each other within the pricing platform engine 514.

Referring to FIG. 6A, a table is shown that represents a price responsive behavior database 600 that may be stored at the insurance pricing platform 500 according to some embodiments. The table may include, for example, entries identifying different insurance products available from an insurer. The table may also define fields 602, 604, 606 for each of the entries. The fields 602, 604, 606 may, according to some embodiments, specify: an insurance product 602, an insurance premium 604, a likelihood of sale 606, and a premium adjustment 608. The price responsive behavior database 600 may be created and updated, for example, as interactions with potential customers are collected and stored.

The insurance product 602 may be, for example, a unique alphanumeric code identifying a particular plan that will be offered to potential customers (e.g., bronze, silver, and gold level coverages). The insurance premium 604 may indicate a price determined in accordance with any of the embodiments described herein. The values in the table 600 might be adjusted to improve, for example, an insurer profit, market share, margin, or any other business goal. Note that the table 600 may be created using a huge volume of data in substantially real time (which could not, for example, be manual done by human underwriters). The likelihood of sale 606 may be based on prior interactions with other customers and the premium adjustment 608 may reflect how the insurer might appropriately respond to those interactions. For example, the following formula might be used to determine the premium adjustment 608:

if likelihood of sale 606>20% then premium adjustment 608=increase 5%;

if likelihood of sale 606<5% then premium adjustment 608=decrease 5%;

if likelihood of sale 606≧5% and ≦20% then premium adjustment 608=no change.

FIG. 6B is a tabular portion of a price responsive behavior database 650 according to another embodiment. The table may include, for example, entries identifying different insurance products available from different insurers (e.g., to support a multi-carrier embodiment). The table may also define fields 652, 654, 656 for each of the entries. The fields 652, 654, 656 may, according to some embodiments, specify: an insurance product 652, an insurance premium 654, a request for further information rate 656, and a premium adjustment 658. The price responsive behavior database 650 may be created and updated, for example, as interactions with potential customers are collected and stored.

The insurance product 652 may be, for example, a unique alphanumeric code identifying a particular insurance carrier and plan that will be offered to potential customers (e.g., silver and gold level coverages offered by three different insurance companies). The insurance premium 654 may indicate a price determined in accordance with any of the embodiments described herein. The request for further information rate 656 may be based on prior interactions with other customers (with higher rates indicating that more customers were interested in the product) and the premium adjustment 658 may reflect how the insurer might appropriately respond to those interactions.

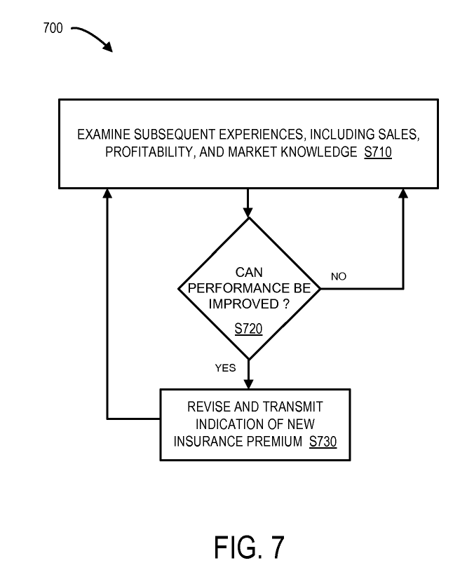

FIG. 7 illustrates a follow-up process flow 700 in accordance with some embodiments. In this example, the insurer may examine subsequent experiences, including sales, profitability and market knowledge at S710. If performance may be improved at S720, the insurer may feedback the relevant information to a pricing engine, revise the premium as appropriate, and transmit an indication of the new premium at S730.

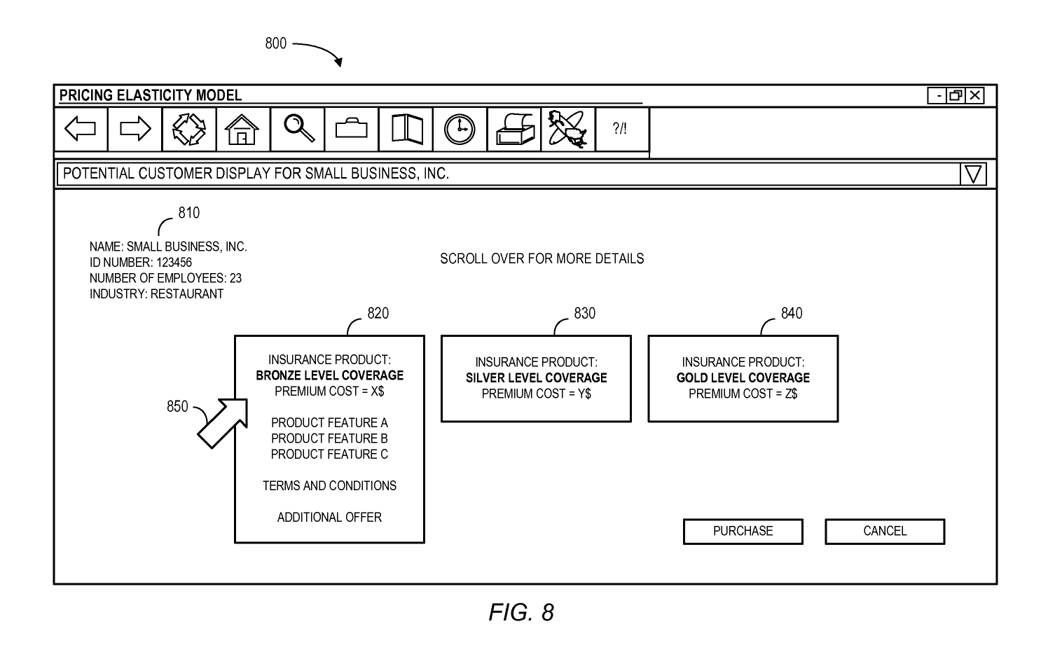

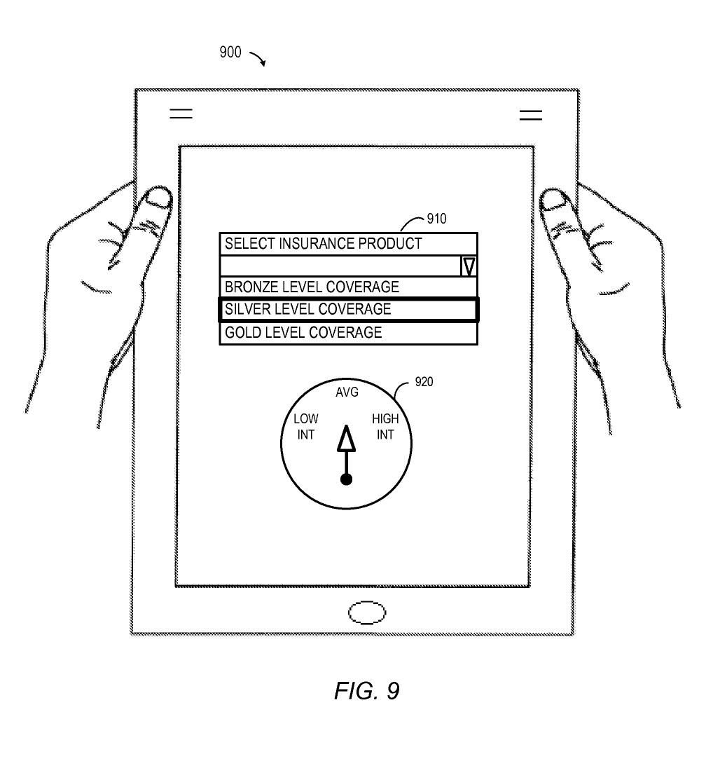

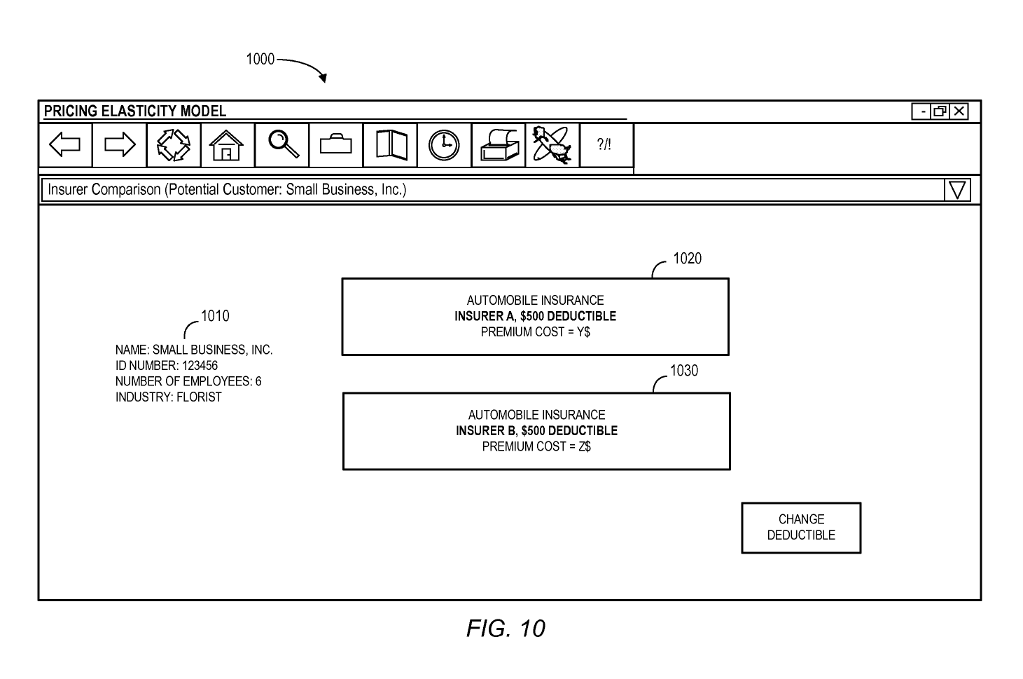

Note that collected potential insurance customer price responsive behavior information may be associated with a plurality of different insurance products offered by a single insurer. For example, FIG. 8 illustrates a computer display 800, for a first potential customer 810, having multiple insurance products 820, 830, 840 (at various price points $X, $Y, and $Z) in accordance with some embodiments described herein. Moreover, the potential customer 810 might move his or her mouse pointer 850 (or use a touch screen) to see more details for a particular product (as illustrated in FIG. 8 by the expended display area for the “Bronze Level Coverage” product 820). A system may use interactions with such a display 800, for example, to track how many options were offered, how many unique insurers offered options (as described with respect to FIG. 10), which carriers offered options, what was the price of each product, what was the range between lowest priced and the most expensive priced product (as a percentage or dollar amount), what was the distribution (standard deviation) of price offerings (as a percentage or dollar amount). The system might also track which products were selected first by customers based on price (e.g., what was its price relative to the mean and median and/or by brand). Similarly, the total number of products opened by potential customers might be tracked along with the frequency of the openings. Still further, the position of each product on the display 800 might be analyzed with respect to subsequent customer interactions (e.g., do most customers simply click on the leftmost offering regardless of relative price levels?). FIG. 9 illustrates a handheld tablet results display 900 according to some embodiments described herein. In particular, an operator might use the display 900 to select a particular insurance product 910 and view a dashboard like result 920 for that product in substantially real time (e.g., how many customers have expressed an interest in the insurance product during the last 24 hours).

According to some embodiments, collected potential insurance customer price responsive behavior information may be associated with a plurality of similar insurance products offered by different insurers. For example, FIG. 10 illustrates a computer display 1000 for a first potential insurance customer 1010 in connection with multiple insurers 1020, 1030 (insurer A and insurer B) in accordance with some embodiments described herein. The system might track, for example, the frequency of success (e.g., the customer makes a purchase) for each insurance offered, whether the customer opened up all the options to receive further details, what did the customer click on first (e.g., do customers usually look at the cheapest product first), was there a preference for a specific insurer), does customer behavior change with the magnitude of the purchase (do customers shop differently and are they more or less interested in prices if the insurance products being considered are approximately $100 as compared to $1,000?). The value in collecting this type of information may be to increase opportunities to improve prices and profit and/or adjust the amount of discounts being offered. Moreover, such an approach may reduce the need to rely on anecdotal feedback offered by agents and others that is often processed without using scientific methods to capture and distill the data.

In general, and for the purposes of introducing concepts of embodiments of the present invention, a computer system may incorporate a “predictive model” that may, for example, establish premium pricing functions. As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. The predictive model may be trained with historical premium and claim transaction data, and may be applied to a new insurance product to help determine a pricing function. Both the historical data and data representing the new policy might include, according to some embodiments, indeterminate data or information extracted therefrom. For example, such data/information may come from narrative and/or medical text notes associated with a claim file.

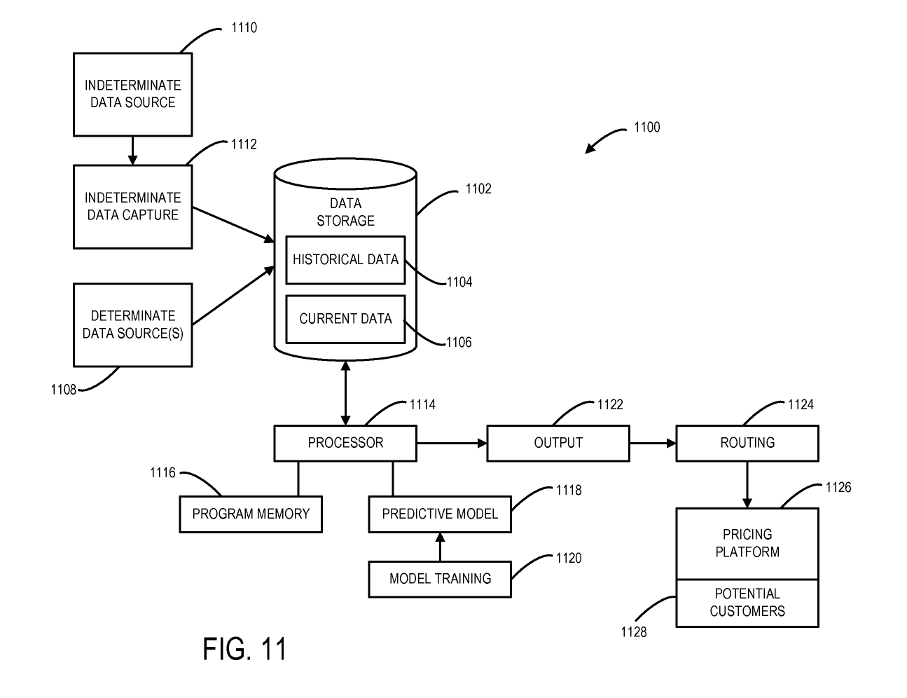

Features of some embodiments associated with a predictive model will now be described by first referring to FIG. 11. FIG. 11 is a block diagram that illustrates aspects of a computer system 1100 provided in accordance with some embodiments of the invention. For present purposes it will be assumed that the computer system 1100 is operated by an insurance company (not separately shown) for the purpose of appropriately pricing insurance products.

The computer system 1100 includes a data storage module 1102. In terms of its hardware the data storage module 1102 may be conventional, and may be composed, for example, by one or more magnetic hard disk drives. A function performed by the data storage module 1102 in the computer system 1100 is to receive, store and provide access to both historical data (reference numeral 1104) and current data, such as potential customer census data and interaction data (reference numeral 1106). As described in more detail below, the historical data 1104 is employed to train a predictive model to provide an output that indicates how an insurance product might be priced. Moreover, as time goes by, and results become known from processing current data, at least some of the current data may be used to perform further training of the predictive model. Consequently, the predictive model may thereby adapt itself to changing patterns of customer interactions.

Either the historical data 1104 or the current data 1106 might include, according to some embodiments, determinate and indeterminate data. As used herein and in the appended claims, “determinate data” refers to verifiable facts such as the date of birth, age or name of a claimant or name of another individual or of a business or other entity; a type of injury, accident, sickness, or pregnancy status; a medical diagnosis; a date of loss, or date of report of claim, or policy date or other date; a time of day; a day of the week; a vehicle identification number, a geographic location; and a policy number.

As used herein and in the appended claims, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes might be associated with, for example, a prior injury or obesity related co-morbidity information.

The determinate data may come from one or more determinate data sources 1108 that are included in the computer system 1100 and are coupled to the data storage module 1102. The determinate data may include “hard” data like an employee's name, date of birth, social security number, policy number, address; a date of loss; a date the claim was reported, etc. One possible source of the determinate data may be the insurance company's policy database (not separately indicated). Another possible source of determinate data may be from a human resources database or data entry by an employer.

The indeterminate data may originate from one or more indeterminate data sources 1110, and may be extracted from raw files or the like by one or more indeterminate data capture modules 1112. Both the indeterminate data source(s) 1110 and the indeterminate data capture module(s) 1112 may be included in the computer system 1100 and coupled directly or indirectly to the data storage module 1102. Examples of the indeterminate data source(s) 1110 may include data storage facilities for document images, for text files (e.g., claim handlers' notes) and digitized recorded voice files (e.g., participants' statements to a telephone call center). Examples of the indeterminate data capture module(s) 1112 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1100 also may include a computer processor 1114. The computer processor 1114 may include one or more conventional microprocessors and may operate to execute programmed instructions to provide functionality as described herein. Among other functions, the computer processor 1114 may store and retrieve historical data 1104 and data 1106 in and from the data storage module 1102. Thus the computer processor 1114 may be coupled to the data storage module 1102.

The computer system 1100 may further include a program memory 1116 that is coupled to the computer processor 1114. The program memory 1116 may include one or more fixed storage devices, such as one or more hard disk drives, and one or more volatile storage devices, such as RAM (random access memory). The program memory 1116 may be at least partially integrated with the data storage module 1102. The program memory 1116 may store one or more application programs, an operating system, device drivers, etc., all of which may contain program instruction steps for execution by the computer processor 1114.

The computer system 1100 further includes a predictive model component 1118. In certain practical embodiments of the computer system 1100, the predictive model component 1118 may effectively be implemented via the computer processor 1114, one or more application programs stored in the program memory 1116, and data stored as a result of training operations based on the historical data 1104. In some embodiments, data arising from model training may be stored in the data storage module 1102, or in a separate data store (not separately shown). A function of the predictive model component 1118 may be to determine an appropriate pricing for group benefit insurance plans. The predictive model component 1118 may be directly or indirectly coupled to the data storage module 1102.

The predictive model component 1118 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1100 includes a model training component 1120. The model training component 1120 may be coupled to the computer processor 1114 (directly or indirectly) and may have the function of training the predictive model component 1118 based on the historical data 1104. (As will be understood from previous discussion, the model training component 1120 may further train the predictive model component 1118 as further relevant data becomes available.) The model training component 1120 may be embodied at least in part by the computer processor 1114 and one or more application programs stored in the program memory 1116. Thus the training of the predictive model component 1118 by the model training component 1120 may occur in accordance with program instructions stored in the program memory 1116 and executed by the computer processor 1114.

In addition, the computer system 1100 may include an output device 1122. The output device 1122 may be coupled to the computer processor 1114. A function of the output device 1122 may be to provide an output that is indicative of (as determined by the trained predictive model component 1118) pricing for an insurance product. The output may be generated by the computer processor 1114 in accordance with program instructions stored in the program memory 1116 and executed by the computer processor 1114. More specifically, the output may be generated by the computer processor 1114 in response to applying the data for the current data 1106 to the trained predictive model component 1118. The output may, for example, be a number within a predetermined range of numbers. In some embodiments, the output device may be implemented by a suitable program or program module executed by the computer processor 1114 in response to operation of the predictive model component 1118.

Still further, the computer system 1100 may include a routing module 1124. The routing module 1124 may be implemented in some embodiments by a software module executed by the computer processor 1114. The routing module 1124 may have the function of directing workflow based on the output from the output device. Thus the routing module 1124 may be coupled, at least functionally, to the output device 1122. In some embodiments, for example, the routing module may provide pricing information to a potential customers 1128 (e.g., via a web site).

The predictive model 1118, in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the insurance company. The specific data and outcomes analyzed vary depending on the desired functionality of the particular predictive model 1118. The particular data parameters selected for analysis in the training process are determined by using regression analysis and/or other statistical techniques known in the art for identifying relevant variables in multivariable systems. The parameters can be selected from any of the structured data parameters stored in the present system, whether the parameters were input into the system originally in a structured format or whether they were extracted from previously unstructured text.

Thus, embodiments described herein may examine current and/or past potential customer interactions to provide a sense of magnitude as to what it might have taken to win, or keep, new business. Moreover, lost opportunity costs may be predicted and reviews may be periodic on a substantially real time basis. Moreover, adjustments might not lag market realities because consumer purchasing behavior is used to accurately determine a current relative positioning of the product and pricing to the marketplace.

Note that the present invention provides significant technical improvements to insurance premium pricing technology. The present invention is directed to more than merely a computer implementation of a routine or conventional activity previously known in the industry as it significantly advances the technical efficiency, access and/or accuracy of insurance premium pricing by implementing a specific new method and system as defined herein. The present invention is a specific advancement in the area of insurance premium pricing by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in the present invention hundreds of thousands insurer-customer interactions may be automatically analyzed to adjust insurance premiums to an appropriate level.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system for enhanced communications between an interaction server and a remote device, the system comprising:
an insurance risk factor computer storage unit for receiving, storing, and providing risk factor data associated with the commercial insurance product;
an insurance loss experience computer storage unit for receiving, storing, and providing loss experience data associated with the commercial insurance product;
a potential insurance customer interaction server that has interacted with remote potential insurance customer devices and collected potential insurance customer price responsive behavior information associated with the commercial insurance product; and
a pricing platform processor in communication with the insurance risk factor computer storage unit, the insurance loss experience computer storage unit, and the potential insurance customer interaction server, wherein the processor is configured for:
receiving information from a first remote potential insurance customer device associated with a first potential insurance customer,
automatically calculating, for the first potential insurance customer, an insurance premium for the commercial insurance product based on at least the risk factor data, the loss experience data, and the collected potential insurance customer price responsive behavior information, and
automatically transmitting an indication of the calculated insurance premium to the first potential insurance customer device.

2. The system of claim 1, wherein the commercial insurance product is associated with at least one of: (i) workers' compensation insurance, (ii) disability insurance, (iii) property insurance, (iv) automobile insurance, and (v) life insurance.

3. The system of claim 1, wherein the collected potential insurance customer price responsive behavior information is associated with indications of interest received from potential customers.

4. The system of claim 1, wherein the collected potential insurance customer price responsive behavior information is associated with purchases made by potential customers.

5. The system of claim 1, wherein the collected potential insurance customer price responsive behavior information is associated with a plurality of different commercial insurance products offered by a single insurer.

6. The system of claim 1, wherein the collected potential insurance customer price responsive behavior information is associated with a plurality of similar commercial insurance products offered by different insurers.

7. The system of claim 1, wherein the transmitted indication is associated with at least one of: (i) an email server, (ii) a workflow application, (iii) a calendar application, (iv) an advertisement, (v) an offer, and (vi) a social networking web site.

8. The system of claim 7, wherein an indication of acceptance is received from the first remote potential insurance customer and, responsive to the received indication, automatically facilitating a sale of the commercial insurance product.

9. The system of claim 8, wherein, subsequent to said sale, experiences, including sales, profitability, and market knowledge data are evaluated to feedback and adjust said calculated insurance premium.

10. A computerized method for communicating between a customer device and a platform processor, the method comprising:
receiving insurance risk factor data associated with the insurance product;
receiving insurance loss experience data associated with the insurance product;
interacting with remote potential insurance customer devices to collect potential insurance customer price responsive behavior information associated with the insurance product;
receiving, by a pricing platform processor, information from a first remote potential insurance customer device associated with a first potential insurance customer,
automatically calculating by the pricing platform processor, for the first potential insurance customer, an insurance premium for the insurance product based on at least the insurance risk factor data, the insurance loss experience data, and the collected potential insurance customer price responsive behavior information; and
automatically transmitting an indication of the calculated insurance premium to the first potential insurance customer device.

11. The method of claim 10, wherein the insurance product is associated with at least one of: (i) workers' compensation insurance, (ii) disability insurance, (iii) property insurance, (iv) automobile insurance, and (v) life insurance.

12. The method of claim 10, wherein the collected potential insurance customer price responsive behavior information is associated with indications of interest received from potential customers.

13. The method of claim 10, wherein the collected potential insurance customer price responsive behavior information is associated with purchases made by potential customers.

14. The method of claim 10, wherein the collected potential insurance customer price responsive behavior information is associated with a plurality of different insurance products offered by a single insurer.

15. The method of claim 10, wherein the collected potential insurance customer price responsive behavior information is associated with a plurality of similar insurance products offered by different insurers.

16. A communications system for transmitting data between an interaction server and a remote device, the system comprising:
an insurance risk factor computer storage unit for receiving, storing, and providing risk factor data associated with the insurance product;
an insurance loss experience computer storage unit for receiving, storing, and providing loss experience data associated with the insurance product;
a potential insurance customer interaction server that has interacted with remote potential insurance customer devices and collected potential insurance customer price responsive behavior information associated with the insurance product; and
a pricing platform processor in communication with the insurance risk factor computer storage unit, the insurance loss experience computer storage unit, and the potential insurance customer interaction server, wherein the processor is configured for:
receiving information from a first remote potential insurance customer device associated with a first potential insurance customer,
automatically calculating, for the first potential insurance customer, an insurance premium for the insurance product based on at least the risk factor data, the loss experience data, and the collected potential insurance customer price responsive behavior information, and
automatically transmitting an indication of the calculated insurance premium to the first potential insurance customer device.

17. The system of claim 16, wherein the insurance product is associated with at least one of: (i) workers' compensation insurance, (ii) disability insurance, (iii) property insurance, (iv) automobile insurance, and (v) life insurance.

18. The system of claim 16, wherein the collected potential insurance customer price responsive behavior information is associated with indications of interest received from potential customers.

19. The system of claim 16, wherein the collected potential insurance customer price responsive behavior information is associated with purchases made by potential customers.

20. The system of claim 16, wherein the collected potential insurance customer price responsive behavior information is associated with a plurality of different insurance products offered by a single insurer.

21. The system of claim 16, wherein the collected potential insurance customer price responsive behavior information is associated with a plurality of similar insurance products offered by different insurers.
